(19) United States
(12) Patent Application Publication
(10) Pub. No.: US 2009/0128056 A1
(43) Pub. Date: May 21, 2009

(54) LIGHT-EMITTING DEVICE

(76) Inventor: Chung-Jyh LIN, (US)

Correspondence Address: BIRCH STEWART KOLASCH & BIRCH, PO BOX 747, FALLS CHURCH, VA, 22040-0747, US

(21) Appl. No.: 12/269,596

(22) Filed: Nov. 12, 2008

(30) Foreign Application Priority Data
Nov. 16, 2007 (TW) 096143617

(51) Int. Cl. H05B 37/02

(52) U.S. Cl. 315/301

(57) ABSTRACT

A light-emitting device includes a plurality of light-emitting units, a plurality of non-address-embedded brightness control integrated circuits (ICs) and at least one system control unit. Each of the brightness control ICs is electrically connected to each of the light-emitting units. The system control unit addresses each of the brightness control ICs by outputting at least one addressing signal through an external circuit, and writes a brightness control signal to each of the brightness control ICs. Each brightness control IC controls each of the light-emitting units according to the received brightness control signal.

### CROSS REFERENCE TO RELATED APPLICATIONS

This Non-provisional application claims priority under 35 U.S.C. §119(a) on Patent Application No(s). 096143617 filed in Taiwan, Republic of China on Nov. 16, 2007, the entire contents of which are hereby incorporated by reference.

### BACKGROUND OF THE INVENTION

1. Field of Invention

The present invention relates to a light-emitting device and, more particularly, to a light-emitting device having a non-address-embedded brightness control integrated circuit (IC).

2. Related Art

In the liquid crystal display (LCD) device, a cold cathode fluorescent lamp (CCFL) is usually used as the light-emitting unit of a backlight module. However, since the CCFL does not perform as well as the LED, some manufacturers have already chosen the LED as the light source of the backlight module in the LCD device as the LED technology is maturing.

The LCD device, such as the LCD TV, has a backlight module that needs tens to hundreds of LEDs. For a better display image, each of the LEDs has to be controlled for the needed light intensity.

The control technology is to control the plurality of LEDs by a brightness control integrated circuit (IC). When there is the plurality of brightness control ICs, a specific address recorded on each of the brightness control ICs is used for addressing. Furthermore, the addresses of all brightness control ICs are also stored in a system control unit, and a brightness control signal is transmitted according to each specific address by the system control unit, such that each of the brightness control ICs can be controlled to perform the brightness control to the corresponding LED. However, in the above-mentioned control technology, because different addresses have to be recorded on the brightness control circuits, respectively, this would increase the complexity of the manufacturing process and the material management, as well as the cost.

Therefore, it is an important subject to provide a light-emitting device that can control each LED without recording a specific address on the corresponding brightness control IC so as to simplify the manufacturing process and material management and reduce the cost.

### SUMMARY OF THE INVENTION

In view of the foregoing, the present invention is to provide a brightness control integrated circuit (IC) that can control each of the light-emitting diodes (LEDs) without having a specific address recorded, hence simplify the manufacturing process and reduce the cost.

To achieve the above, a light-emitting device according to the present invention includes a plurality of light-emitting units, a plurality of non-address-embedded brightness control integrated circuits (ICs) and at least one system control unit. Each of the brightness control ICs is electrically connected to each of the light-emitting units. The system control unit addresses each of the brightness control ICs by outputting at least one addressing signal through an external circuit, and writes a brightness control signal to each of the brightness control ICs. Each of the brightness control ICs controls each of the light-emitting units in accordance with the received brightness control signal.

As mentioned above, the brightness control IC of a light-emitting device according to the present invention is non address-embedded; instead, it is addressed through the external circuit connected to each of the brightness control ICs. The system control unit addresses each of the brightness control ICs by transmitting the addressing signal through the external circuit, and transmits the brightness control signal to the addressed brightness control ICs, such that the brightness control circuit controls the light-emitting unit in accordance with the brightness control signal. In addition, the external circuit may be used repeatedly so as to decrease the circuit layouts and hence reduce the size of the circuit board and lower the cost. Compared to the prior art, the address does not need to be recorded on the brightness control IC in the present invention, so the manufacturing process and the material management can be simplified and hence reduce the cost.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a light-emitting device according to a preferred embodiment of the present invention;

FIG. 2 is a schematic view of the light-emitting device using a first control method according to the preferred embodiment of the present invention;

FIG. 3A is a schematic view of a latch comparing unit of the light-emitting device in FIG. 2;

FIG. 3B is a schematic view of an XNOR gate of the latch comparing unit in FIG. 3A;

FIG. 3C is another schematic view of the light-emitting device using the first control method according to the preferred embodiment of the present invention;

FIG. 3D is a signal waveform graph of the light-emitting device using the first control method according to the preferred embodiment of the present invention;

FIG. 4 is a schematic view of the light-emitting device using a second control method according to the preferred embodiment of the present invention;

FIG. 5 is a signal waveform graph of the light-emitting device using the second control method according to the preferred embodiment of the present invention;

FIG. 6 is a schematic view of the light-emitting device using a third control method according to the preferred embodiment of the present invention;

FIG. 7A is a schematic view of a shift register unit of the light-emitting device using the third control method according to the preferred embodiment of the present invention;

FIG. 7B is a schematic view of a comparing unit of the light-emitting device using the third control method according to the preferred embodiment of the present invention;

FIG. 8 is a schematic view of the light-emitting device using a fourth control method according to the preferred embodiment of the present invention; and

FIG. 9 is a schematic view of the light-emitting device using a fifth control method according to the preferred embodiment of the present invention.

### DETAILED DESCRIPTION OF THE INVENTION

The present invention will be apparent from the following detailed description, which proceeds with reference to the accompanying drawings, wherein the same references relate to the same elements.

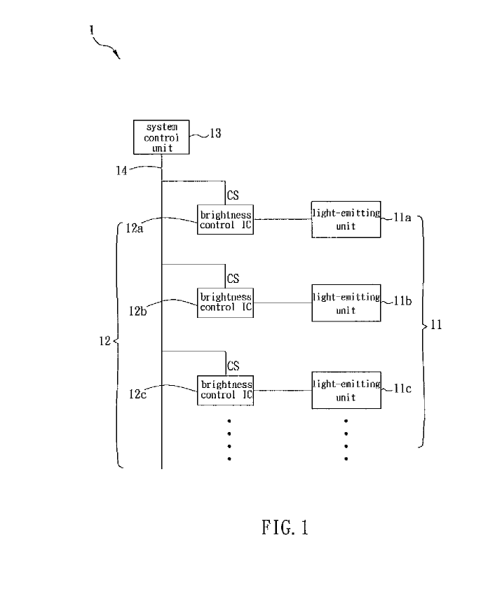

FIG. 1 is a schematic view of a light-emitting device 1 according to a preferred embodiment of the present invention. With reference to FIG. 1, a light-emitting device 1 according to a preferred embodiment of the present invention includes a plurality of light-emitting units 11 (11a, 11b . . . ), a plurality of non-address-embedded brightness control integrated circuits (ICs) 12 (12a, 12b . . . ) and at least one system control unit 13. Each of the brightness control ICs 12 is electrically connected to each of the light-emitting units 11 and is electrically connected to the system control unit 13 through an external circuit 14. The external circuit 14 is disposed to the outside of the system control unit 13 for addressing the brightness control IC 12.

In the embodiment, at least two brightness control ICs 12 is non address-embedded, which means, the address information is not recorded or stored on the brightness control IC 12 when it is fabricated. The brightness control IC 12 does not reach an address destination by its own address information, but through the external circuit 14 connected to each of the brightness control ICs 12. The system control unit 13 addresses each of the brightness control ICs 12 by transmitting the addressing signal through the external circuit 14, and transmits the brightness control signal CS to the addressed brightness control IC 12. Thus the brightness control IC 12 controls the corresponding light-emitting unit 11 in accordance with the received brightness control signal CS. The light-emitting unit 11 may be a light-emitting diode (LED) chip, a cold cathode fluorescent lamp (CCFL), and other light-emitting elements. The brightness control signal CS may be an analog signal or a digital signal.

In the embodiment, the brightness control IC 12 may reach the address destination by connecting to the external circuit 14 in different ways, which means, the total number of signal lines used by the addressing signal may be smaller than the total number of the brightness control ICs 12. Furthermore, as shown in FIG. 1, the brightness control signal CS and the addressing signal may share the same signal line.

There are several ways to control in the present invention. They are illustrated as follow but not used to limit the scope of the present invention.

### First Control Method

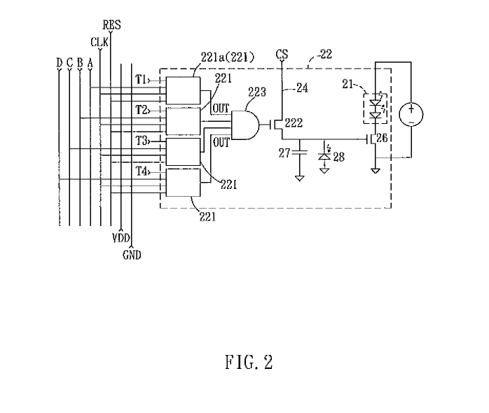

FIG. 2 is a schematic view of the light-emitting device using a first control method according to the preferred embodiment of the present invention. With reference to FIG. 2, each of the brightness control ICs 22 receives a pulse signal CLK, a plurality of first comparing signals A to D, and a plurality of second comparing signals T1 to T4. Each of the brightness control ICs 22 includes a plurality of latch comparing units 221 and an AND gate 223. Each of the latch comparing units 221 receives a first comparing signal and a second comparing signal. For example, a latch comparing unit 221a receives the first comparing signal A and the second comparing signal T1, and the rest of the latch comparing units 221 receive other comparing signals as shown in FIG. 2. Additionally, each of the latch comparing units 221 also receives a reset signal RES.

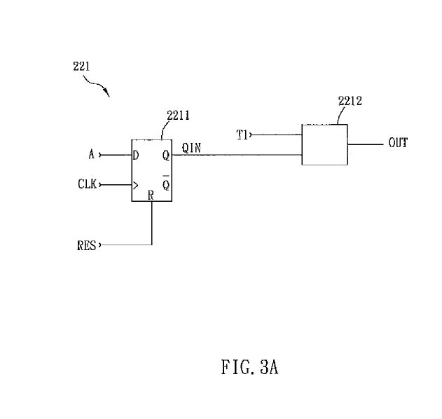

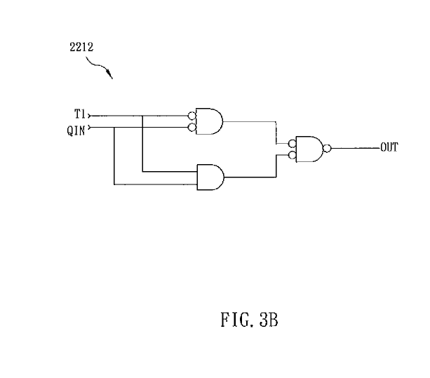

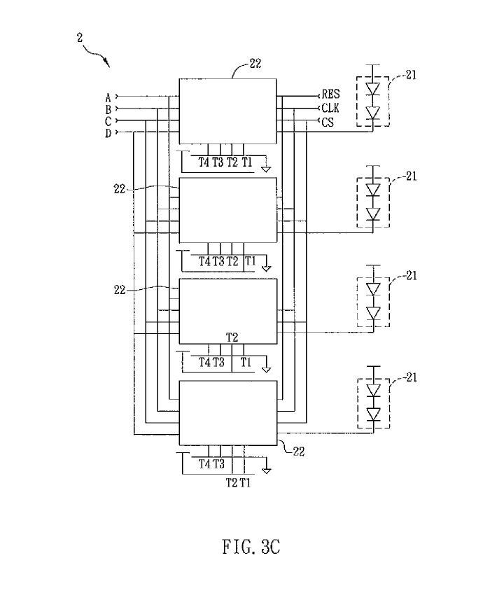

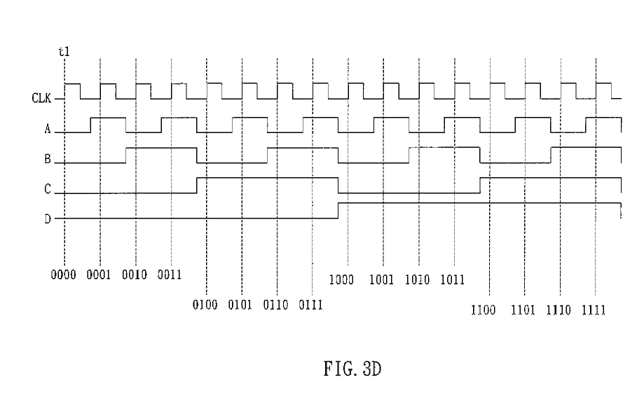

FIG. 3A illustrates an aspect of the latch comparing unit 221 of the embodiment. The latch comparing unit 221 has a flip-flop 2211 and an XNOR gate 2212. The flip-flop 2211 receives the first comparing signal A, the pulse signal CLK, and the reset signal RES, and outputs a signal QIN to the XNOR gate 2212 in accordance with the pulse signal CLK. FIG. 3B illustrates an aspect of the XNOR gate 2212 of the embodiment. The XNOR gate 2212 outputs a signal OUT to the AND gate 223 in accordance with the second comparing signal T1 and the signal QIN (as shown in FIG. 2). If the second comparing signal T1 and the signal QIN are the same, the value of signal OUT is 1. If the second comparing signal T1 and the signal QIN are not the same, the value of signal OUT is 0.

With reference to FIG. 2, four latch comparing units 221 may respectively output a signal OUT to the AND gate 223. When the signals OUT are 1, the AND gate 223 outputs a signal to activate a switching unit 222. Such that the brightness control signal CS may be written to the brightness control IC 22 through the brightness control signal line 24 and the switching unit 222, which means, the brightness control IC 22 determines whether to receive the brightness control signal CS in accordance with the comparing result of the first comparing signals A to D and the second comparing signals T1 to T4. If the signals are the same, the brightness control IC 22 is addressed for receiving the brightness control signal CS. By doing so, the brightness control IC 22 may control the light-emitting unit 21 in accordance with the brightness control signal CS.

In addition, each of the brightness control ICs 22 further includes a switching unit 26, a charge storage unit 27, and a photo sensing control unit 28. The switching unit 26, the light-emitting unit 21, the photo sensing control unit 28, the charge storage unit 27, and the switching unit 222 are electrically connected to each other. Moreover, the switching unit 26 and the light-emitting unit 21 are connected in series, and the light sensing control unit 28 and the charge storage unit 27 are connected in parallel in the embodiment.

When the brightness control signal CS is written to the brightness control IC 22 through the switching unit 222, the charge storage unit 27 stores an amount of electric charges in accordance with the brightness control signal CS. If the amount of the electric charges is sufficient to activate the switching unit 26, the light-emitting unit 21 emits the light in accordance with the supplied current. At the same time as the light-emitting unit 21 emits the light, the photo sensing control unit 28 senses the light intensity and the current leakage generates according to the sensed light intensity. Therefore, the amount of the electric charges of the charge storage unit 27 starts to decrease. If the amount of the electric charges decreases so much that the switching unit 26 cannot be activated, the light-emitting unit 21 will stop emitting the light. By doing so, the average brightness can be adjusted by the lighting time of the light-emitting unit 21.

In the embodiment, the switching units 26 and 222 may include a bipolar transistor or a field effect transistor. The charge storage unit 27 may include a capacitor. The photo sensing control unit 28 may include a photodiode.

FIG. 3C is a block diagram of the plurality of the brightness control ICs 22 of the light-emitting device 2. With reference to FIG. 3C, the operation of each brightness control IC 22 is the same as that of the above-described brightness control IC.

With reference to FIG. 3C, each of the brightness control ICs 22 has at least 12 pins for receiving the first comparing signals A to D, the second comparing signals T1 to T4, the reset signal RES, the pulse signal CLK, and the brightness control signal CS. Each brightness control IC 22 has a pin electrically connected to the light-emitting unit 21. The second comparing signals T1 to T4 of each brightness control IC 22 are inputted according to the binary coding method, and they can be the VDD, GND, or preset values generated by the external circuit of each brightness control IC 22. FIG. 3D is a waveform graph of the first comparing signals A to D and the pulse signal CLK. The first comparing signals A to D may have 16 types of signal variations according to the pulse signal CLK. Hence the embodiment may perform respective control to 16 brightness control ICs 22. As a matter of course, other signal variations may be added if necessary for corresponding to the increased number of the brightness control ICs 22.

The following examples illustrate how the pulse signal CLK performs respective control to the brightness control ICs at different point of time. For example, when the value of the first comparing signals A to D is “0, 0, 0, 0” at time t1 of the pulse signal CLK, the brightness control IC can be controlled if the input value of the second comparing signals T1 to T4 to the desired brightness control IC is “0, 0, 0, 0” at time t1, and so forth for the rest of the time points, thus the detailed description thereof will be omitted. By doing so, the brightness control signal CS is written sequentially to the brightness control IC 22 according to the comparing result of the first comparing signals A to D and the second comparing signals T1 to T4.

As a matter of course, the second comparing signals T1 to T4 may be a preset value such as “0, 0, 0, 0”. As the system control unit is desired to control one of the brightness control ICs at time t1, it would be fine if the brightness control IC inputs the first comparing signals A to D having a value of “0, 0, 0, 0” at time t1.

### Second Control Method

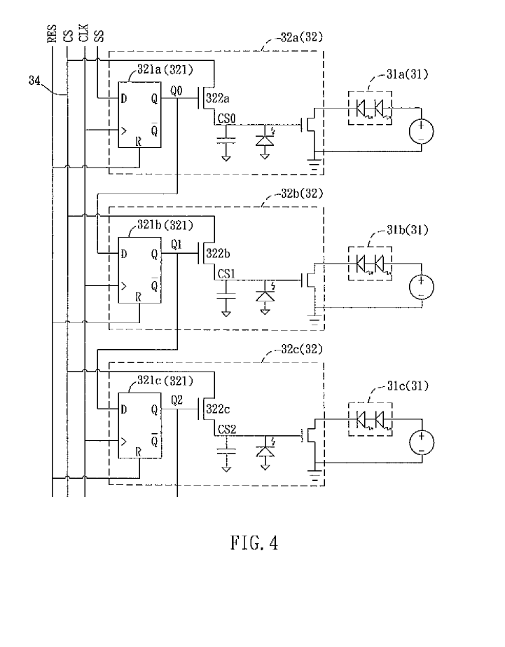

FIG. 4 is a schematic view of the light-emitting device using a second control method according to the preferred embodiment of the present invention. With reference to FIG. 4, each of the brightness control ICs 32 has a register unit 321 (321a, 321b . . . ), and the register units 321 are connected to each other in series and receive a pulse signal CLK and a reset signal RES. In the embodiment, each register unit 321 includes a flip-flop.

The register unit 321 sequentially outputs an enabling signal such as Q0 or Q1 in accordance with the pulse signal CLK. The first level register unit 321a receives a selecting signal SS and outputs the enabling signal Q0. The rest of the register units 321b, 321c . . . receives the enabling signals from the register unit of the previous level and outputs the enabling signals Q1, Q2 . . . .

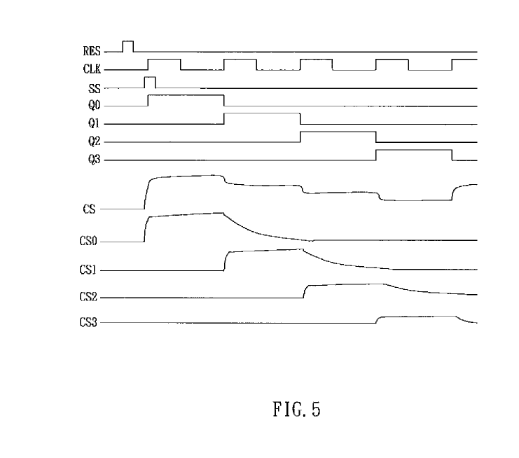

FIG. 5 is a waveform graph of the reset signal RES, the pulse signal CLK, the selecting signal SS, the enabling signals Q0, Q1, and Q2 . . . , and the brightness control signals CS, CS0, and CS1 . . . . With reference to FIGS. 4 and 5, as the register unit 321a receives the selecting signal SS and the pulse signal CLK, the register unit 321a outputs an enabling signal Q0 to the switching unit 322a and the register unit 321b. As the enabling signal Q0 is outputted to the switching unit 322a, the switching unit 322a is activated, such that the brightness control signal CS0 may be written to the brightness control IC 32a through the brightness control signal line 34, which means, the brightness control IC 32a is addressed for receiving the brightness control signal CS0. Since the way that the brightness control IC 32a controls the light-emitting unit 31a by the brightness control signal CS0 has been described above, the detailed description thereof will thus be omitted.

Moreover, as the register unit 321b receives the enabling signal Q0 from the register unit 321a, the register unit 321b outputs the enabling signal Q1 to the switching unit 322b and the register unit 321c a cycle delayed in accordance with the pulse signal CLK and the enabling signal Q0. As the enabling signal Q1 is inputted to the switching unit 322b, the switching unit 322b is activated such that the brightness control signal CS1 can be written to the brightness control IC 32b through the brightness control signal line 34, which means, the brightness control IC 32b is addressed for receiving the brightness control signal CS1. Since the way that the brightness control IC 32b controls the light-emitting unit 31b by the brightness control signal CS1 has been described above, the detailed description thereof will thus be omitted.

Because the register units 321 are connected to each other in series, the register unit 321 is able to output the enabling signals Q0, Q1 . . . , such that the brightness control signals CS0, CS1 . . . are sequentially written to the brightness control ICs 32a, 32b . . . so as to control the light-emitting units 31a, 31b . . . .

### Third Control Method

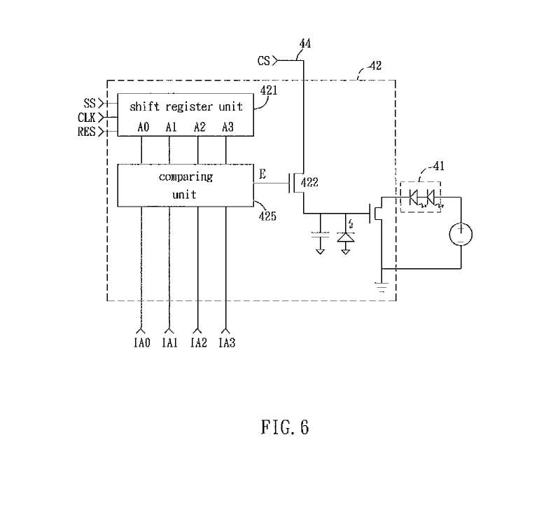

FIG. 6 is a schematic view of the light-emitting device using a third control method according to the preferred embodiment of the present invention. With reference to FIG. 6, each of the brightness control ICs 42 has a shift register unit 421 and a comparing unit 425 that are electrically connected to each other. After the shift register unit 421 serially receives a selecting signal SS, a set of the first comparing signals A0 to A3 is outputted in parallel to the comparing unit 425. The comparing unit 425 compares the first comparing signals A0 to A3 and a set of the second comparing units IA0 to IA3. Each of the brightness control ICs 42 determines whether to receive the brightness control signal CS in accordance with the comparing result of the first comparing signals A0 to A3 and the second comparing signals IA0 to IA3. In the embodiment, as the set of the first comparing signals A0 to A3 and the set of the second comparing signals IA0 to IA3 are the same, the brightness control signal CS is written to the brightness control IC 42.

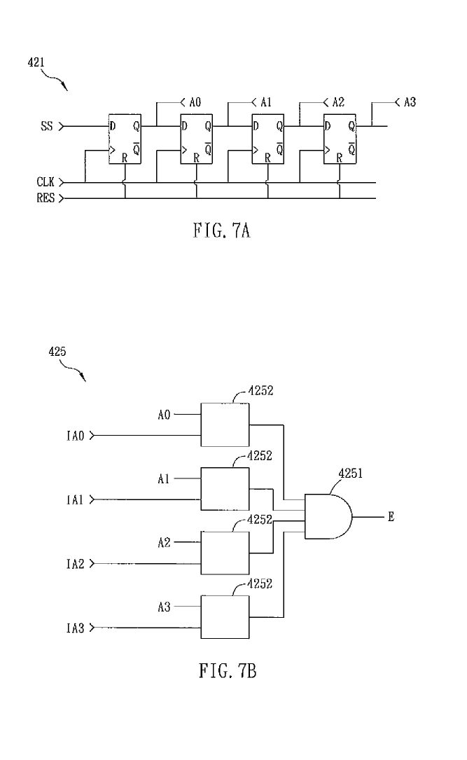

FIG. 7A is a circuit diagram showing an aspect of the shift register unit 421. The shift register unit 421 includes a shift register that has a plurality of flip-flops. As shown in FIG. 7B, which is a schematic view of a comparing unit 425 of the light-emitting device using the third control method according to the preferred embodiment of the present invention, the comparing unit 425 includes a comparator.

The comparing unit 425 compares the first comparing signals A0, A1, A2, and A3 to a set of the second comparing signals IA0, IA1, IA2, and IA3. The comparing unit 425 may be implemented by a plurality of XNOR gates 4252 and an AND gate 4251. As the first comparing signals A0, A1, A2, and A3 are respectively the same as the second comparing signals IA0, IA1, IA2, and IA3, the switching unit 422 is activated by an enabling signal E, such that the brightness control signal CS is written to the brightness control IC 42 through the switching unit 422. Hence, each of the brightness control signals CS can be written to each of the brightness control ICs 42 through the brightness control signal line 44 by the selecting signal SS and the second comparing signals IA0, IA1, IA2, and IA3, so as to control each light-emitting unit 41. Since the way that the brightness control IC 42 controls the light-emitting unit 41 by the brightness control signal CS has been described above, the detailed description thereof will be omitted.

### Fourth Control Method

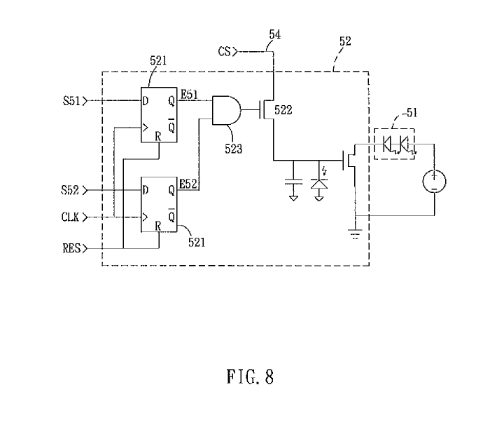

FIG. 8 is a schematic view of the light-emitting device using a fourth control method according to the preferred embodiment of the present invention. With reference to FIG. 8, each of the brightness control ICs 52 has a plurality of register units 521, for example, two register units 521 in the embodiment. The register units 521 output the enabling signals E51 and E52, respectively, in accordance with the selecting signals S51 and S52. As the enabling signals E51 and E52 are the same, the brightness control signal CS is written to the brightness control IC 52 through the switching unit 522, which means, the brightness control IC 52 is addressed for receiving the brightness control signal CS. In the embodiment, an AND gate 523 is used to determine whether the enabling signals E51 and E52 are the same. As a matter of course, the AND gate 523 can also determine that the enabling signals E51 and E52 are not the same and thus addresses the brightness control IC 52.

Therefore, each of the brightness control signals CS can be written to each of the brightness control ICs 52 through the brightness control signal line 54 by the different selecting signals, so as to control each light-emitting unit 51. Since the way that the brightness control IC 52 controls the light-emitting unit 51 by the brightness control signal CS has been described above, the detailed description thereof will be omitted.

### Fifth Control Method

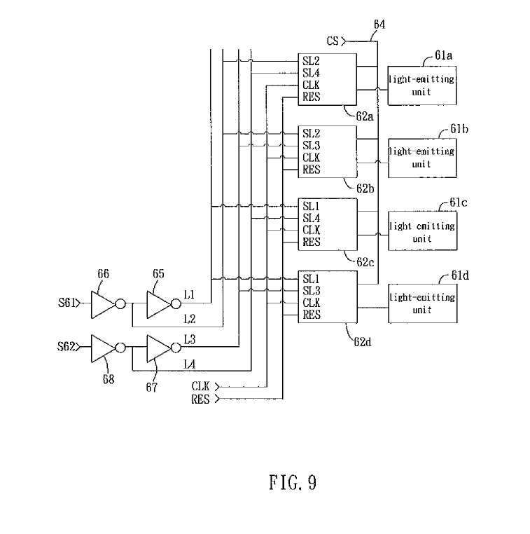

FIG. 9 is a schematic view of the light-emitting device using a fifth control method according to the preferred embodiment of the present invention. With reference to FIG. 9, the light-emitting device has plurality sets of inverting signal lines, such as the set of inverting signal lines L1 and L2, and the set of inverting signal lines L3 and L4. Each of the brightness control ICs 62a, 62b . . . is connected to one of the inverting signal lines of each set without repeating the same route. For example, each brightness control IC is connected to the inverting signal line L1 or L2, and the inverting signal line L3 or L4. Each set of inverting signal lines transmits a set of inverting signals. For example, the set of inverting signal lines L1 and L2 transmits a set of inverting signals SL1 and SL2, and the set of inverting signal lines L3 and L4 transmits a set of inverting signals SL3 and SL4. Four inverting units 65, 66, 67, and 68 generate four inverting signals SL1, SL2, SL3, and SL4 according to selecting signals S61 and S62. Each of the inverting units 65, 66, 67, and 68 may include a flip-flop.

Table 1 is a truth value table of the selecting signals S61 and S62, and the inverting signals SL1, SL2, SL3, and SL4.

TABLE 1

| | |
|---|---|
| Selecting signal | Inverting signal |

| S61 | S62 | SL1 | SL2 | SL3 | SL4 |
|---|---|---|---|---|---|
| 0 | 0 | 0 | 1 | 0 | 1 |
| 0 | 1 | 0 | 1 | 1 | 0 |
| 1 | 0 | 1 | 0 | 0 | 1 |
| 1 | 1 | 1 | 0 | 1 | 0 |

According to Table 1, the brightness control ICs 62a, 62b . . . may work separately with four different combinations of the selecting signals S61 and S62, which means, the brightness control ICs 62a, 62b, 62c, and 62d are addressed respectively. For example, as the selecting signals S61 and S62 are “0, 0”, the inverting signals SL1, SL2, SL3, and SL4 are “0, 1, 0, 1”, therefore the brightness control IC 62a connected to the inverting signal lines L2 and L4 can work. In the embodiment, the brightness control IC 62a may have an AND gate, which outputs an enabling signal in accordance with the inverting signals SL2 and SL4, so as to control the light-emitting unit 61a by writing the brightness control signal CS to the brightness IC 62a through the brightness control signal line 64. Since the way that the brightness control ICs 62b, 62c, and 62d control the light-emitting units 61b, 61c, and 61d have been described above, the detailed description thereof will be omitted.

To sum up, the brightness control IC of a light-emitting device according to the present invention is non-address-embedded but addressed through the external circuit connected to each brightness control IC. The system control unit addresses each of the brightness control ICs by transmitting the addressing information through the external circuit, and transmits the brightness control signal to the addressed brightness control IC, such that the brightness control IC controls the light-emitting unit according to the brightness control signal. Moreover, the external circuit may be used repeatedly so as to decrease the circuit layouts, hence reduce the size of the circuit board and lower the cost. Compared to the prior art, the address is not recorded on the brightness control circuit in the present invention, so the manufacturing process and the material management are simplified and the cost can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting devices comprising:
a plurality of light-emitting units;
a plurality of non-address-embedded brightness control integrated circuits (ICs) electrically connected to the light-emitting units; and
at least one system control unit addressing each of the brightness control ICs by outputting at least one addressing signal through an external circuit, and writing a brightness control signal to each of the brightness controls ICs, wherein each of the brightness control ICs controls each of the light-emitting units according to the received brightness control signal.

2. The light-emitting device according to claim 1, wherein a total number of signal lines for the addressing signals is smaller than a total number of the brightness control ICs.

3. The light-emitting device according to claim 1, wherein the addressing signal and the brightness control signal share the same signal line.

4. The light-emitting device according to claim 1, wherein the brightness control signal is an analog signal or a digital signal.

5. The light-emitting device according to claim 1, wherein each of the brightness control ICs receives a plurality of first comparing signals and a plurality of second comparing signals, and determines whether to receive the brightness control signal in accordance with the comparing result of the first comparing signals and the second comparing signals.

6. The light-emitting device according to claim 5, wherein the first comparing signals are generated by the system control unit and the second comparing signals are preset values respectively generated by the external circuits of the brightness control ICs.

7. The light-emitting device according to claim 5, wherein each of the brightness control ICs comprises a plurality of latch comparing units and an AND gate.

8. The light-emitting device according to claim 7, wherein each of the latch comparing units comprises a flip-flop and an XNOR gate.

9. The light-emitting device according to claim 1, wherein each of the brightness control ICs comprises a register unit, and the register units are connected to each other in series and receive a pulse signal.

10. The light-emitting device according to claim 9, wherein the register units output an enabling signal sequentially in accordance with the pulse signal so as to write the brightness control signals sequentially to the brightness control ICs.

11. The light-emitting device according to claim 9, wherein the register unit comprises a flip-flop.

12. The light-emitting device according to claim 1, wherein each of the brightness control ICs comprises a shift register unit and a comparing unit electrically connected to the shift register unit.

13. The light-emitting device according to claim 12, wherein after the shift register unit serially receives a selecting signal, the shift register unit outputs a set of first comparing signals to the comparing unit in parallel.

14. The light-emitting device according to claim 13, wherein the comparing unit compares the set of first comparing signals to a set of second comparing signals, and each of the brightness control ICs determines whether to receive the brightness control signal in accordance with the comparing result of the set of first comparing signals and the set of second comparing signals.

15. The light-emitting device according to claim 14, wherein when the set of first comparing signals is the same as the set of second comparing signals, the brightness control signal is written to the brightness control IC.

16. The light-emitting device according to claim 12, wherein the shift register unit comprises a plurality of flip-flops.

17. The light-emitting device according to claim 1 further comprising a plurality sets of inverting signal lines, wherein each of the brightness control ICs is connected to a signal line in each set of inverting signal lines, and each set of inverting signal lines transmits a set of inverting signals.

18. The light-emitting device according to claim 17, wherein the set of inverting signal lines is generated by a plurality of inverting units.

19. The light-emitting device according to claim 1, wherein each of the brightness control ICs further comprises:
a first switching unit electrically connected to the light-emitting unit;
a charge storage unit electrically connected to the first switching unit and storing an amount of electric charges in accordance with the brightness control signal; and
a photo sensing control unit electrically connected to the charge storage unit, sensing a light-emitting energy of the light-emitting unit, and adjusting the amount of electric charges in accordance with the light-emitting energy, wherein the first switching unit controls the light-emitting unit in accordance with the amount of electric charges.

20. The light-emitting device according to claim 19, wherein the charge storage unit comprises a capacitor.

21. The light-emitting device according to claim 19, wherein the photo sensing control unit comprises a photodiode.

22. The light-emitting device according to claim 19, wherein the photo sensing control unit is connected in parallel to the charge storage unit.

23. The light-emitting device according to claim 19, wherein each of the brightness control ICs further comprises a second switching unit electrically connected to the charge storage unit for inputting the amount of electric charges to the charge storage unit.

24. The light-emitting device according to claim 1, wherein the light-emitting unit is a light-emitting diode (LED) chip or a cold cathode fluorescent lamp (CCFL).
